(19) United States
(12) Patent Application Publication
(10) Pub. No.: US 2021/0372224 A1
(43) Pub. Date: Dec. 2, 2021

(54) ROTATING CONTROL DEVICE WITH ACTIVE MATERIAL

(71) Applicant: Cameron International Corporation, Houston, TX (US)

(72) Inventors: Jon Tyler, Houston, TX (US); Yawan Couturier, Katy, TX (US); Harold Tenorio, Houston, TX (US); Blaine Dow, Sugar Land, TX (US)

(21) Appl. No.: 16/885,335

(22) Filed: May 28, 2020

(51) Int. Cl. E21B 33/12; F16J 15/43

(52) U.S. Cl. CPC E21B 33/1208; F16J 15/43

(57) ABSTRACT

A rotating control device (RCD) includes a housing defining a bore, a seal element supported within the housing and configured to form a seal against a tubular within the bore, and an active material within the housing. The active material is configured to deform upon application of a magnetic field or an electric field to thereby adjust the seal against the tubular.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Natural resources have a profound effect on modern economies and societies. In order to meet the demand for such natural resources, numerous companies invest significant amounts of time and money in searching for, accessing, and extracting oil, natural gas, and other natural resources. Particularly, once a desired natural resource is discovered below the surface of the earth, drilling systems are often employed to access the desired natural resource. These drilling systems can be located onshore or offshore depending on the location of the desired natural resource. Such drilling systems may include a drilling fluid system configured to circulate drilling fluid into and out of a wellbore to facilitate drilling the wellbore.

### BRIEF DESCRIPTION OF THE DRAWINGS

Various features, aspects, and advantages of the present disclosure will become better understood when the following detailed description is read with reference to the accompanying figures in which like characters represent like parts throughout the figures, wherein:

FIG. 1 is a schematic diagram of a drilling system, in accordance with an embodiment of the present disclosure;

FIG. 2 is a cross-sectional side view of a rotating control device (RCD) that may be used in the drilling system of FIG. 1, wherein the RCD is in a first configuration and includes a push element formed from an active material, in accordance with an embodiment of the present disclosure;

FIG. 3 is a cross-sectional side view of the RCD of FIG. 2, wherein the RCD is in a second configuration, in accordance with an embodiment of the present disclosure;

FIG. 4 is a cross-sectional side view of an RCD that may be used in the drilling system of FIG. 1, wherein the RCD includes a bearing, in accordance with an embodiment of the present disclosure;

FIG. 5 is a cross-sectional side view of an RCD that may be used in the drilling system of FIG. 1, wherein the RCD includes a push element having a portion formed from an active material, in accordance with an embodiment of the present disclosure;

FIG. 6 is a cross-sectional side view of an RCD that may be used in the drilling system of FIG. 1, wherein the RCD includes a chamber that houses an active material, in accordance with an embodiment of the present disclosure;

FIG. 7 is a cross-sectional side view of an RCD that may be used in the drilling system of FIG. 1, wherein the RCD includes a seal element having a portion formed from an active material, in accordance with an embodiment of the present disclosure;

FIG. 8 is a cross-sectional side view of an RCD that may be used in the drilling system of FIG. 1, wherein the RCD includes a seal element formed from an active material, in accordance with an embodiment of the present disclosure; and

FIG. 9 is a flow diagram of a method of operating an RCD, wherein the method includes activating an active material of the RCD to adjust a seal formed by the RCD against a tubular extending through the RCD, in accordance with an aspect of the present disclosure.

### DETAILED DESCRIPTION OF SPECIFIC EMBODIMENTS

One or more specific embodiments of the present disclosure will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” “said,” and the like, are intended to mean that there are one or more of the elements. The terms “comprising,” “including,” “having,” and the like are intended to be inclusive and mean that there may be additional elements other than the listed elements. The use of “top,” “bottom,” “above,” “below,” and variations of these terms is made for convenience, but does not require any particular orientation of the components relative to some fixed reference, such as the direction of gravity. The drawing figures are not necessarily to scale. Certain features and components herein may be shown exaggerated in scale and/or in somewhat schematic form. Some details may not be shown in the interest of clarity and conciseness.

A drilling system may include a drilling fluid system that is configured to circulate drilling fluid into and out of a wellbore to facilitate drilling the wellbore. For example, the drilling fluid system may provide a flow of the drilling fluid through a drill string as the drill string rotates a drill bit that is positioned at a distal end portion of the drill string. The drilling fluid may exit through one or more openings at the distal end portion of the drill string and may return toward a platform of the drilling system via an annular space between the drill string and a casing that lines the wellbore.

In some cases, the drilling system may use managed pressure drilling (“MPD”). MPD regulates a pressure and a flow of the drilling fluid within the drill string so that the flow of the drilling fluid does not over pressurize a well (e.g., expand the well) and/or blocks the well from collapsing under its own weight. The ability to manage the pressure and the flow of the drilling fluid enables use of the drilling system to drill in various locations, such as locations with relatively softer sea beds.

The drilling system of the present disclosure may include a rotating control device (RCD) that includes at least one component formed from an active material (e.g., smart material) that is configured to change in response to application of a magnetic field or an electric field. For example, the active material may be a magnetostrictive material that is configured to deform (e.g., deflect, change shape, expand, shrink, bend) in response to application of a magnetic field, the active material may be a magnetorheological fluid (e.g., grease) that is configured to experience a change in viscosity in response to application of a magnetic field, or the active material may be an electroactive polymer that is configured to deform in response to application of an electric field.

In operation, the application of the magnetic field or the electric field may cause the active material to deform or to otherwise change, which may result in formation of and/or an adjustment to a seal formed between a seal element of the RCD and the drill string extending through the RCD. The seal formed between the seal element of the RCD and the drill string extending through the RCD may block fluid flow through the annular space that surrounds the drill string. For example, the seal may be formed and/or tightened to block the drilling fluid, cuttings, and/or natural resources (e.g., carbon dioxide, hydrogen sulfide) from passing across the RCD from the well toward the platform. In some embodiments, the fluid flow may be diverted toward another suitable location (e.g., a collection tank) other than the platform.

The seal element of the RCD may form the seal against the drill string as the drill string rotates and/or moves axially within the wellbore. In some embodiments, the active material enables the RCD to provide an adjustable and dynamic seal against the drill string, and the drill string may rotate or slip against the seal element as the drill string rotates and/or moves axially within the wellbore. However, in some embodiments, the RCD may include one or more bearings to facilitate rotation of the seal element of the RCD with the drill string as the drill string rotates and/or moves axially within the wellbore (e.g., the seal element of the RCD may be driven to rotate by the drill string).

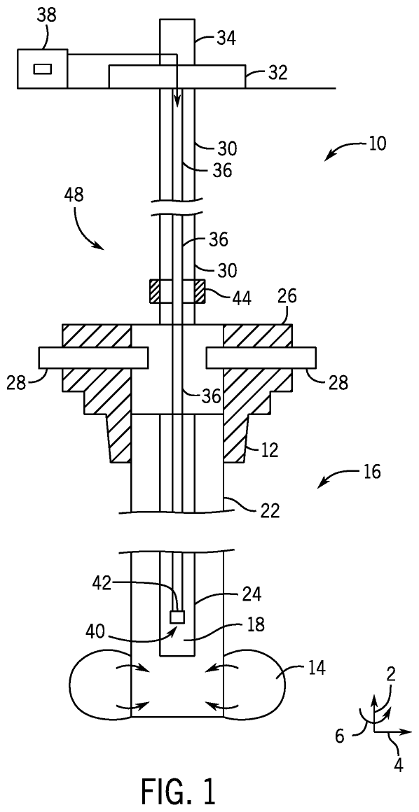

FIG. 1 is a schematic diagram that illustrates an embodiment of a drilling system 10 that is configured to carry out drilling operations. The drilling system 10 may be a subsea system, although the disclosed embodiments may be used in a land-based (e.g., surface) system. The drilling system 10 may use MPD techniques. As illustrated, the drilling system 10 includes a wellhead assembly 12 coupled to a mineral deposit 14 via a well 16 having a wellbore 18.

The wellhead assembly 12 may include or be coupled to multiple components that control and regulate activities and conditions associated with the well 16. For example, the wellhead assembly 12 generally includes or is coupled to pipes, bodies, valves, and seals that enable drilling of the well 16, route produced minerals from the mineral deposit 14, provide for regulating pressure in the well 16, and provide for the injection of drilling fluids into the wellbore 18. A conductor 22 may provide structure for the wellbore 18 and may block collapse of the sides of the well 16 into the wellbore 18. A casing 24 may be disposed within the conductor 22. The casing 24 may provide structure for the wellbore 18 and may facilitate control of fluid and pressure during drilling of the well 16. The wellhead assembly 12 may include a tubing spool, a casing spool, and a hanger (e.g., a tubing hanger or a casing hanger) to enable installation of the casing 24. As shown, the wellhead assembly 12 may include or be coupled to a blowout preventer (BOP) assembly 26, which may include one or more BOPs (e.g., one or more ram BOPs, one or more annular BOPs, or a combination thereof). For example, the BOP assembly 26 shown in FIG. 1 includes a ram BOP having moveable rams 28 configured to seal the wellbore 18.

A drilling riser 30 may extend between the BOP assembly 26 and a platform 32. The platform 32 may include various components that facilitate operation of the drilling system 10, such as pumps, tanks, and power equipment. The platform 32 may also include a derrick 34 that supports a tubular 36 (e.g., drill string), which may extend through the drilling riser 30. A drilling fluid system 38 may direct the drilling fluid into the tubular 36, and the drilling fluid may exit through one or more openings at a distal end portion 40 of the tubular 36 and may return (along with cuttings and/or other substances from the well 16) toward the platform 32 via an annular space (e.g., between the tubular 36 and the casing 24 that lines the wellbore 18; between the tubular 36 and the drilling riser 30). A drill bit 42 may be positioned at the distal end portion 40 of the tubular 36. The tubular 36 may rotate within the drilling riser 30 to rotate the drill bit 42, thereby enabling the drill bit 42 to drill and form the well 16.

As shown, the drilling system 10 may include a rotating control device (RCD) 44 that is configured to block fluid flow through the annular space that surrounds the tubular 36. For example, the RCD 44 may be configured to block the drilling fluid, cuttings, and/or other substances from the well 16 from passing across the RCD 44 from the well 16 toward the platform 32. The RCD 44 may be positioned at any suitable location within the drilling system 10, such as any suitable location between the wellbore 18 and the platform 32. For example, as shown, the RCD 44 may be positioned along the drilling riser 30 (e.g., in-line with the drilling riser 30) and between the BOP assembly 26 and the platform 32.

In operation, the tubular 36 may be rotated and/or moved along an axial axis 2 to enable the drill bit 42 to drill the well 16. As discussed in more detail below, the RCD 44 may be controlled to provide a seal against the tubular 36. The drilling system 10 and its compo even as the tubular 36 is rotated and/or moved along the axial axis 2. The RCD 44 and its components may be described with reference to the axial axis 2 (or axial direction), a radial axis 4 (or radial direction), and a circumferential axis 6 (or direction) to facilitate discussion.

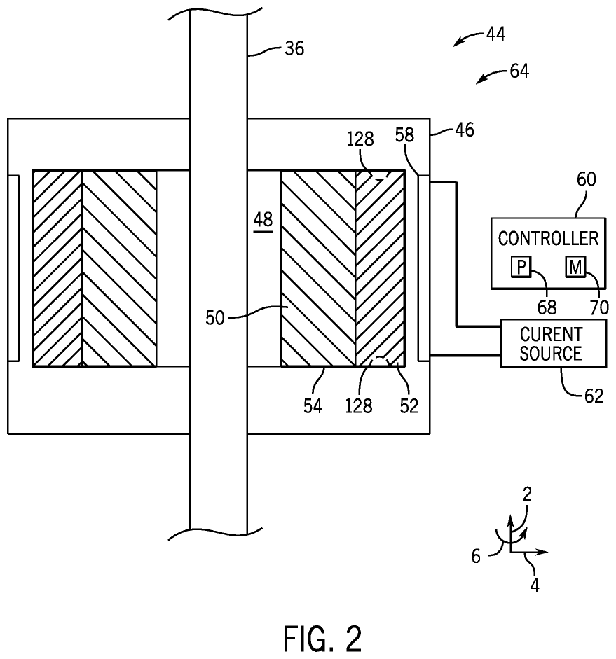

FIG. 2 is a cross-sectional side view of an embodiment of the RCD 44 that may be used in the drilling system of FIG. 1. As shown, the RCD 44 includes a housing 46, a bore 48 extending through the housing 46, a seal element 50 (e.g., annular seal element) positioned within the housing 46, and a push element 52 (e.g., annular push element; push ring; donut) positioned within the housing 46. The seal element 50 and the push element 52 may be supported within a cavity 54 (e.g., annular cavity) defined within the housing 46, and the push element 52 may circumferentially surround the seal element 50.

The seal element 50 may be any suitable seal material, such as an elastomer material. The push element 52 may be any suitable push material, such as an elastomer material. In the illustrated embodiment, the push element 52 is formed from an active material (e.g., smart material) that is configured to change, such as to deform (e.g., deflect, change shape, expand, shrink, bend), in response to application of a magnetic field. For example, the push element 52 may be formed from an elastomer material with ferromagnetic (e.g., iron) particles embedded therein. Upon application of a magnetic field, such as via a current flow through one or more electromagnets 58 (e.g., electromagnetic coils or windings), the push element 52 may deform and adjust the seal element 50.

It should be appreciated that the seal element 50 and/or the push element 52 may be an annular structure that wraps circumferentially around the bore 48. However, the seal element 50 and/or the push element 52 may each include multiple separate segments (e.g., that extend about a half, a quarter, or an eighth of a circumference of the bore 48 at least while the RCD 44 is in a configuration to form the seal against the tubular 36). Additionally, the electromagnets 58 may be arranged in any suitable manner that enables the electromagnets 58 to generate a magnetic field to cause the change in the push element 52. For example, the electromagnets 58 may be positioned radially-outwardly of the push element 52 and/or may be distributed circumferentially around the push element 52. The electromagnets 58 may be supported by and/or positioned within the housing 46 and/or may be spaced apart along the circumferential axis 56.

In operation, a controller 60 (e.g., electronic controller) may control delivery of a current from a current source 62 (e.g., battery) to the electromagnets 58. For example, the controller 60 may control a switch to adjust between an open position in which the current does not pass through the electromagnets 58 and a closed position in which the current does pass through the electromagnets 58 to thereby generate a magnetic field. The controller 60 may also control a strength of the magnetic field by controlling an amount of current that flows from the current source 62 through the electromagnets 58, and the strength of the magnetic field may affect the change (e.g., a degree of the change, such as a degree of the deformation) of the push element 52. Thus, by controlling the amount of current, the controller 60 may control adjustment of the seal element 50.

The controller 60 may control the delivery of the current from the current source 62 to the electromagnets 58 based on any of a variety of inputs, such as in response to an input received from a user interface device at the platform (e.g., from an operator) and/or in response to an input received from one or more sensors, such as one or more sensors that monitor one or more parameters indicative of a seal formed between the seal element 50 and the tubular 36, wellbore conditions, rotation of the tubular 36, or the like. For example, the controller 60 may receive an input that indicates an undesirable pressure below the RCD 44 (e.g., between the wellhead and the RCD 44) and/or above the RCD 44 (e.g., between the platform and the RCD 44) and may then adjust (e.g., increase) the current to the electromagnets 58 to thereby form and/or adjust (e.g., increase) the seal (e.g., sealing force; radial force) between the seal element 50 and the tubular 36. As another example, the controller 60 may receive an input that indicates that the tubular 36 will begin to move or is moving within the RCD 44 (e.g., rotating and/or moving in the axial direction 2), and the controller 60 may then adjust (e.g., increase or decrease) the current to the electromagnets 58 to thereby form and/or adjust (e.g., increase or decrease) the seal between the seal element 50 and the tubular 36. In this way, the RCD 44 may provide an adjustable and dynamic seal about the tubular 36 (e.g., as the tubular 36 rotates and/or moves in the axial direction 2 through the RCD 44).

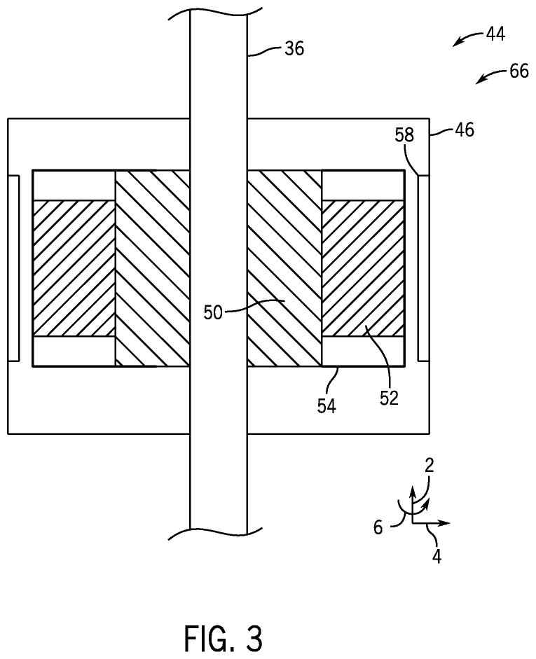

In FIG. 2, the RCD 44 is in a first configuration 64 (e.g., unsealed configuration) in which the seal element 50 does not contact and/or does not seal against the tubular 36, an annular space is provided between the seal element 50 and the tubular 36, and/or the seal element 50 is withdrawn from the bore 48 of the RCD 44. In FIG. 3, the RCD 44 is in a second configuration 66 (e.g., sealed configuration) in which the seal element 50 contacts and/or seals against the tubular 36, the annular space is sealed, and/or the seal element 50 is positioned within the bore 48 of the RCD 44. However, while the seal element 50 is shown as being separated from the tubular 36 in the first configuration 64 as an example to facilitate discussion, it should be appreciated that the seal element 50 may contact and/or seal against the tubular 36 with a first sealing force in the first configuration 64, and the first sealing force in the first configuration 64 is less than a second sealing force in the second configuration 66. Thus, the seal between the seal element 50 and the tubular 36 may change (e.g., formation of the seal and/or tightening of the seal) as the RCD 44 transitions between the first configuration 64 and the second configuration 66, as discussed in more detail below.

In operation (e.g., during drilling operations), the seal element 50 may be adjusted between the first configuration 64 and the second configuration 66 (e.g., in response to one or more inputs). In the illustrated embodiment, the application of the magnetic field causes the push element 52 to deform in a manner that drives the seal element 50 radially-inwardly toward the tubular 36. For example, the application of the magnetic field may cause the push element 52 to expand radially and to thereby drive the seal element 50 radially-inwardly to seal against the tubular 36 and/or to increase the seal against the tubular 36. However, it should be appreciated that the RCD 44 may be configured such that the application of the magnetic field causes the push element 52 to deform in a manner that enables the seal element 50 to relax or move radially-outwardly away from the tubular 36. For example, the application of the magnetic field may cause the push element 52 to shrink radially and to thereby enable the seal element 50 to move radially-outwardly to break the seal against the tubular 36 and/or to decrease the seal against the tubular 36. Thus, the RCD 44 may be generally considered to be a normally-unsealed RCD 44 (e.g., activation of the electromagnets 58 causes the active material to move radially-inwardly) or a normally-sealed RCD 44 (e.g., activation of the electromagnets 58 causes the active material to move radially-outwardly).

As shown in FIG. 2, the controller 60 includes the processor 68 and the memory device 70. It should be appreciated that the controller 60 may be a dedicated controller for the RCD 44 and/or the controller 60 may be part of or include a distributed controller with one or more electronic controllers in communication with one another to carry out the various techniques disclosed herein. The processor 68 may also include one or more processors configured to execute software, such as software for processing signals and/or controlling the components of the RCD 44. The memory device 70 disclosed herein may include one or more memory devices (e.g., a volatile memory, such as random access memory [RAM], and/or a nonvolatile memory, such as read-only memory [ROM]) that may store a variety of information and may be used for various purposes. For example, the memory device 70 may store processor-executable instructions (e.g., firmware or software) for the processor 68 to execute, such as instructions for processing signals and/or controlling the components of the RCD 44. It should be appreciated that the controller 60 may include various other components, such as a communication device that is capable of communicating data or other information (e.g., a current configuration of the RCD 44; whether the current is passing through the electromagnet 58) to various other devices (e.g., a remote computing system or display system at the platform).

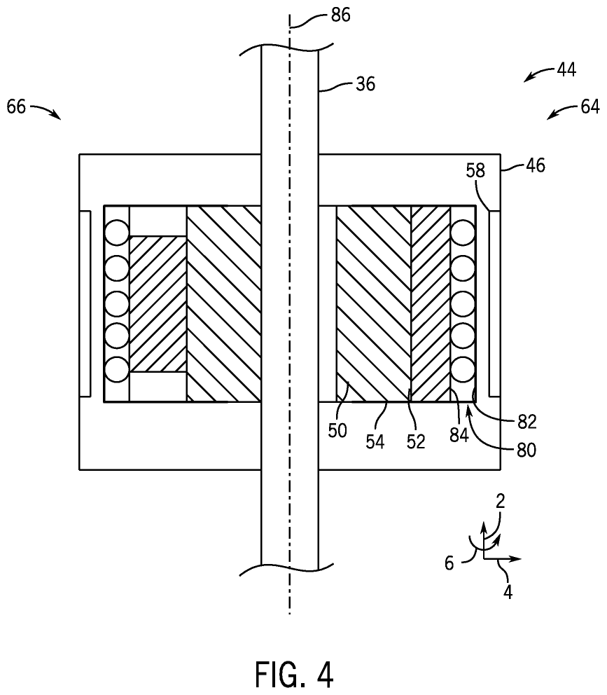

FIG. 4 is a cross-sectional side view of the RCD 44 that may be used in the drilling system of FIG. 1, wherein the RCD 44 includes one or more bearings 80 (e.g., bearing ring; annular bearing; cylindrical bearing). In the illustrated embodiment, the bearing 80 is positioned between a surface 82 (e.g., radially-inner surface) of the cavity 54 and a surface 84 (e.g., radially-outer surface) of the push element 52; however, the bearing 80 may be positioned in any suitable location to enable the seal element 50 and/or the push element 52 to rotate relative to the housing 46. Thus, while the RCD 44 is in the second configuration 66, the rotation of the tubular 36 may drive the rotation of the seal element 50 and/or the push element 52 relative to the housing 46 (e.g., facilitated by the bearing 80). In this way, the tubular 36 may not slip or rotate relative to the seal element 50, which may reduce wear on the seal element 50.

To facilitate discussion, a first portion of FIG. 4 on a first side of an axis 86 is in the first configuration 64 and a second portion of FIG. 4 on a second side of the axis 86 is in the second configuration 66. It should be appreciated that the magnetic field may be applied via the electromagnets 58 (e.g., via control of the current source by the controller), and the magnetic field may cause the push element 52 to deform and to thereby form and/or adjust the seal formed by the seal element 50 (e.g., to drive the seal element 50 radially-inwardly toward the tubular 36).

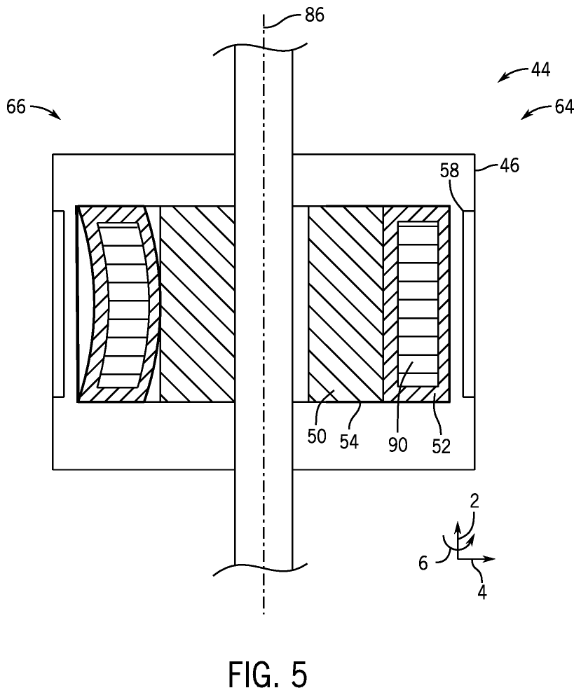

FIG. 5 is a cross-sectional side view of the RCD 44 that may be used in the drilling system of FIG. 1, wherein a portion 90 (e.g., interior portion; annular portion) of the push element 52 is formed from an active material that is configured to change, such as to deform, in response to application of a magnetic field. For example, the portion 90 of the push element 52 may be formed from an elastomer material with ferromagnetic (e.g., iron) particles embedded therein.

It should be appreciated that the portion 90 may be an interior portion that is encapsulated by another material (e.g., inactive material that does not change in response to the application of a magnetic field; elastomer material), the portion 90 may be positioned along or form a radially-inner surface of the push element 52 (e.g., may contact the seal element 50), or the portion 90 may be positioned along or form a radially-outer surface of the push element 52 (e.g., may contact a radially-inner surface of the cavity 54). The portion 90 may have a rectangular cross-sectional shape or any other suitable cross-sectional shape. The portion 90 may occupy a volume that is approximately equal to or greater than about 10, 20, 30, 40, 50, 60, 70, 80, 90 percent or more of a volume of the push element 52. Furthermore, the portion 90 may include multiple separate portions that are spaced apart (e.g., along the axial axis 2, the radial axis 4, and/or the circumferential axis 6) from one another within the push element 52.

In the illustrated embodiment, the application of the magnetic field causes the portion 90 of the push element 52 to deform in a manner that drives the seal element 50 radially-inwardly toward the tubular 36. For example, the application of the magnetic field, via a current flow through the electromagnets 58 as controlled by the controller, causes the portion 90 of the push element 52 to deform (e.g., bend radially-inwardly) and/or to expand radially, and to thereby drive the seal element 50 radially-inwardly to seal against the tubular 36 and/or to increase the seal against the tubular 36. However, as noted above, it should be appreciated that the RCD 44 may be configured such that the application of the magnetic field causes the push element 52 to deform in a manner that enables the seal element 50 to relax or move radially-outwardly toward the tubular 36. For example, the application of the magnetic field may cause the push element 52 to deform (e.g., bend radially-outwardly) and to thereby enable the seal element 50 to move radially-outwardly to break the seal against the tubular 36 and/or to decrease the seal against the tubular 36.

To facilitate discussion, a first portion of FIG. 5 on a first side of the axis 86 is in the first configuration 64 and a second portion of FIG. 5 on a second side of the axis 86 is in the second configuration 66. Additionally, it should be appreciated that the various elements shown and described with reference to FIGS. 2-5 may be combined in any suitable manner. For example, the bearing shown in FIG. 4 may be used with the push element 52 shown in FIG. 5, and the portion 90 shown in FIG. 5 may be configured to expand radially (e.g., rather than bend) and/or the push element 52 in FIGS. 2-4 may be configured to bend (e.g., rather than expand radially).

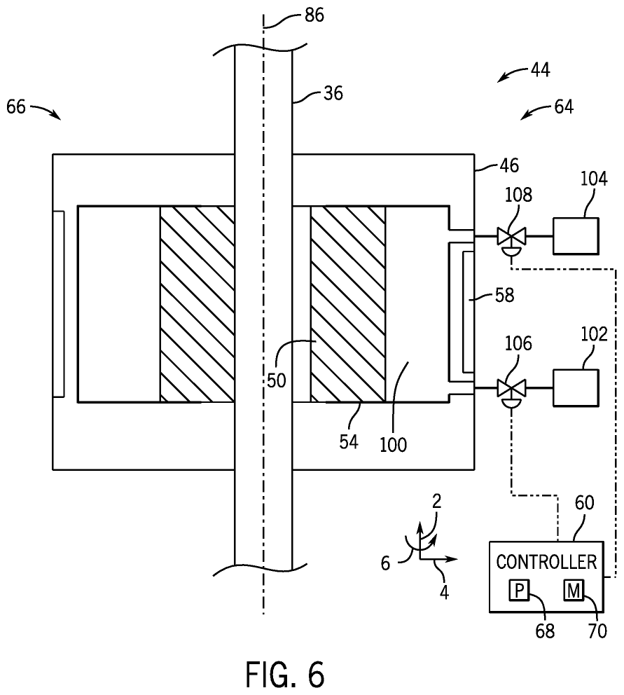

FIG. 6 is a cross-sectional side view of the RCD 44 that may be used in the drilling system of FIG. 1, wherein the RCD 44 includes a chamber 100 (e.g., annular chamber; fluid chamber) that is configured to receive an active material (e.g., active fluid, such as magnetorheological fluid or grease) that is configured to change, such as to change viscosity, in response to application of a magnetic field. As shown, the chamber 100 may be defined between a radially-outer surface of the seal element 50 and a radially-inner surface of the cavity 54. The radially-outer surface of the seal element 50 may form one side of the chamber 100, and thus, the active material may directly contact the seal element 50. It should be appreciated that in some embodiments, a push element (e.g., annular push element; push ring) may be positioned about the seal element 50, and then a radially-outer surface of the push element may form one side of the chamber 100 and the active material may directly contact the push element (e.g., instead of the seal element).

As noted above, the active material may be a magnetorheological fluid, and thus, may include particles (e.g., ferromagnetic particles) suspended within a base fluid (e.g., oil). Upon application of a magnetic field, such as via a current flow through the electromagnets 58, the active material may experience a change (e.g., increase) in viscosity and/or may deform (e.g., change density, volume, compressibility) such that the active fluid may adjust the seal between the seal element 50 and the tubular 36. For example, the change in viscosity may be accompanied by a change in volume to thereby drive the seal element 50 radially-inwardly toward the tubular 36.

Optionally, in some embodiments, the chamber 100 may be open to a fluid circuit that enables circulation of the fluid through the chamber 100. For example, the chamber 100 may include a fluid source 102 and a fluid drain 104. The controller 60 may control a first valve 106 to enable flow from the fluid source 102 to the chamber 100 and/or may control a second valve 108 to enable flow from the chamber 100 to the fluid drain 104. It should be appreciated that the fluid source 102 and the fluid drain 104 may be the same fluid tank and/or may be otherwise fluidly coupled to one another. The circulation of the fluid through the chamber 100 may facilitate suspension of the particles within the base fluid, and may thereby enable the active material to react in a desirable and expected manner to the application of the magnetic field via the electromagnets 58. The valves 106, 108 may be controlled in a coordinated manner, such as to periodically (e.g., hourly, daily) circulate the active material through the chamber 100 and/or to circulate the active material through the chamber 100 at certain times (e.g., while the electromagnets 58 are active or inactive). In some embodiments, the valves 106, 108 may be controlled to effectuate a change in the volume of the active material within the chamber 100, to thereby change the volume of the chamber 100 to drive the seal element 50 radially relative to the tubular 36. For example, the first valve 106 may remain open while the second valve 108 is closed to thereby increase the volume of the active material within the chamber 100. Subsequently, the electromagnets 58 may be activated to increase the viscosity of the active material within the chamber 100 to more finely tune the seal formed between the seal element 50 and the tubular 36. It should be appreciated that the chamber 100 may not be fluidly coupled to any fluid circuit (e.g., permanently isolated) and/or may not be fluidly coupled to any fluid circuit at least during operation of the RCD 44 (e.g., during drilling operations; while the RCD 44 is installed within the drilling system; temporarily isolated).

It should be appreciated that the various elements shown and described with reference to FIGS. 2-6 may be combined in any suitable manner. For example, the bearing shown in FIG. 4 may be used with the chamber 100 shown in FIG. 6. In such cases, the bearing may be positioned radially between the cavity 54 and the housing 46 (e.g., radially between a radially-outer surface of the cavity 54 and a radially-inner surface of the housing 46) and/or a rotary union assembly may be provided to enable a flow of the active material into the chamber 100 in conjunction with rotation of the seal element 50, the chamber 100, and the cavity 54 relative to the housing 46. To facilitate discussion, a first portion of FIG. 6 on a first side of the axis 86 is in the first configuration 64 and a second portion of FIG. 6 on a second side of the axis 86 is in the second configuration 66.

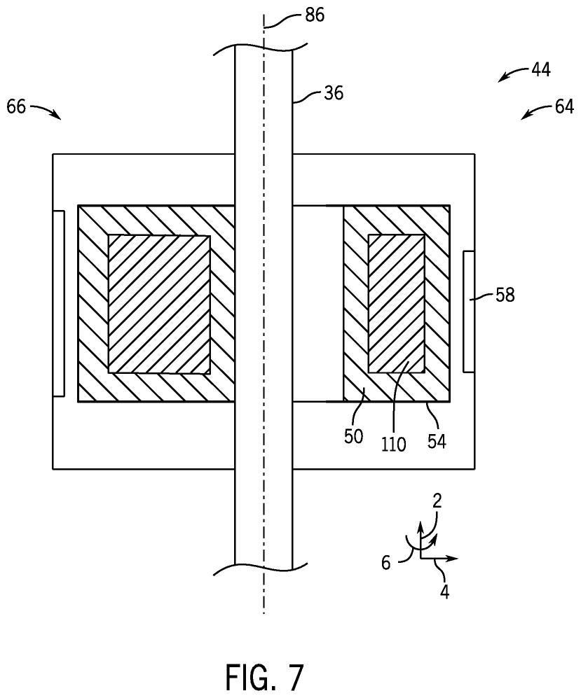

FIG. 7 is a cross-sectional side view of the RCD 44 that may be used in the drilling system of FIG. 1, wherein a portion 110 (e.g., interior portion; annular portion) is formed from an active material that is configured to change, such as to deform, in response to application of a magnetic field. For example, the portion 110 of the seal element 50 may be formed from an elastomer material with ferromagnetic (e.g., iron) particles embedded therein.

It should be appreciated that the portion 110 may be an interior portion that is encapsulated by another material (e.g., inactive material that does not change in response to the application of a magnetic field; elastomer material), the portion 110 may be positioned along or form a radially-inner surface of the seal element 50 (e.g., may contact the tubular 36), or the portion 110 may be positioned along or form a radially-outer surface of the seal element 50 (e.g., may contact a radially-inner surface of the cavity 54). The portion 110 may have a rectangular cross-sectional shape or any other suitable cross-sectional shape. The portion 110 may occupy a volume that is approximately equal to or greater than about 10, 20, 30, 40, 50, 60, 70, 80, 90 percent or more of a volume of the seal element 50. Furthermore, the portion 110 may include multiple separate portions that are spaced apart (e.g., along the axial axis 2, the radial axis 4, and/or the circumferential axis 6) from one another within the seal element 50.

In the illustrated embodiment, the application of the magnetic field causes the portion 110 of the seal element 50 to deform in a manner that drives the seal element 50 radially-inwardly toward the tubular 36. For example, the application of the magnetic field, via a current flow through the electromagnets 58 as controlled by the controller, causes the portion 110 of the seal element 50 to deform (e.g., expand radially) and to thereby drive the seal element 50 radially-inwardly to seal against the tubular 36 and/or to increase the seal against the tubular 36. However, as noted above, it should be appreciated that the RCD 44 may be configured such that the application of the magnetic field causes the portion 110 of the seal element 50 to deform in a manner that enables the seal element 50 to relax or move radially-outwardly toward the tubular 36. For example, the application of the magnetic field may cause the portion 110 of the seal element 50 to deform (e.g., shrink radially) and to thereby enable the seal element 50 to move radially-outwardly to break the seal against the tubular 36 and/or to decrease the seal against the tubular 36.

It should be appreciated that the portion 110 may be a chamber (e.g., closed or open chamber) that is configured to receive an active fluid, such as a magnetorheological fluid. In such cases, the chamber may be an open chamber that is in fluid communication with a fluid circuit in a similar manner as shown in FIG. 6, or the chamber may be a closed chamber that isolates the active fluid within the chamber (e.g., not fluidly coupled to any fluid circuit at least during drilling operations and/or while the RCD 44 is installed within the drilling system). Similarly, with reference to FIG. 5, the portion 90 that is within the push element 52 may also be a chamber (e.g., closed or open chamber) that is configured to receive an active fluid. In any case, the presence of the active material may enable the application of the magnetic field to adjust the seal between the seal element 50 and the tubular 36.

Additionally, to facilitate discussion, a first portion of FIG. 7 on a first side of the axis 86 is in the first configuration 64 and a second portion of FIG. 7 on a second side of the axis 86 is in the second configuration 66. It should be appreciated that the various elements shown and described with reference to FIGS. 2-7 may be combined in any suitable manner. For example, the bearing shown in FIG. 4 may be used with the seal element 50 shown in FIG. 7, and the portion 110 may be configured to bend radially (e.g., rather than expand).

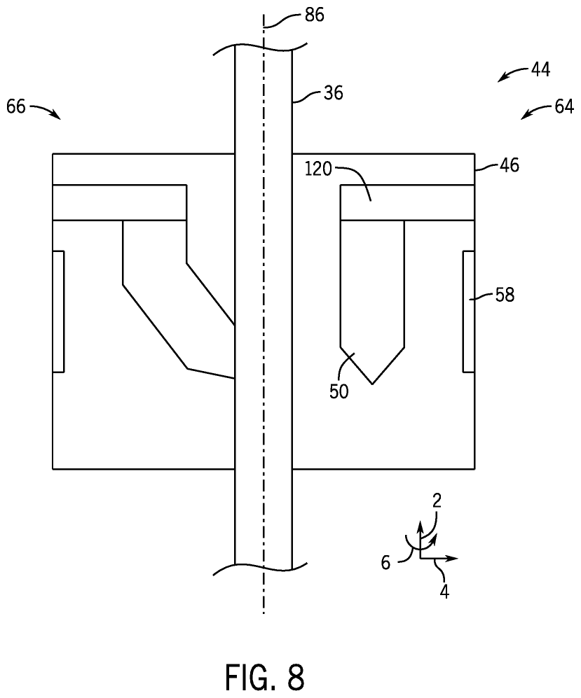

It should be appreciated that an entirety of the seal element 50 may be formed from the active material. For example, the seal element 50 in FIG. 7 may be formed from the active material. The seal element 50 may also have any suitable shape, such as a rectangular cross-sectional shape as shown in FIG. 7 or any other suitable shape. With this in mind, FIG. 8 is a cross-sectional side view of the RCD 44 that may be used in the drilling system of FIG. 1, wherein the seal element 50 that is formed from the active material and has a non-rectangular cross-sectional shape. In FIG. 8, the seal element 50 is suspended from a bracket 120 (e.g., radially-extending bracket; annular bracket). The seal element 50 is configured to bend in response to application of the magnetic field that is generated via the supply of current to the electromagnets 58. In particular, the seal element 50 may bend to move between the first configuration 64 and the second configuration 66 and/or to adjust the seal between the seal element 50 and the tubular 36. The cross-sectional shape and/or the bend of the seal element 50 are merely exemplary to facilitate discussion, and it should be appreciated that the seal element 50 may have any other suitable characteristics that enable the seal element 50 to seal about the tubular 36 via deformation due to the application of the magnetic field.

It should be appreciated that the various elements shown and described with reference to FIGS. 2-8 may be combined in any suitable manner. For example, the bearing shown in FIG. 4 may be used with the seal element 50 shown in FIG. 8 (e.g., between the seal element 50 and the bracket 120; between the bracket 120 and the housing 46). As another example, the active material may be used in multiple components of the RCD 44, such as in two or more of the seal element 50, the push element 52, and the chamber 100.

To facilitate discussion, a first portion of FIG. 8 on a first side of the axis 86 is in the first configuration 64 and a second portion of FIG. 8 on a second side of the axis 86 is in the second configuration 66. It should be appreciated that the magnetic field may be applied via the electromagnets 58 (e.g., via control of the current source by the controller), and the magnetic field may cause the seal element 50 to deform to thereby adjust the seal element 50 (e.g., to move the seal element 50 radially-inwardly toward the tubular 36).

Additionally, any of the active materials (e.g., in the seal element 50, in the push element 52, and/or in the chamber 100) may be electroactive materials (e.g., electroactive polymers; electrorheological fluid). In such cases, the active materials may deform in response to application of an electric field. For example, two electrodes may be positioned to be in contact with the active material, voltage may be provided to the electrodes to generate the electric field, and the active material may then deform in the manner disclosed herein. Electrodes 128 are shown in dashed lines in FIG. 2 to illustrate an example placement, and the electrodes 128 may be utilized in any of the embodiments disclosed herein.

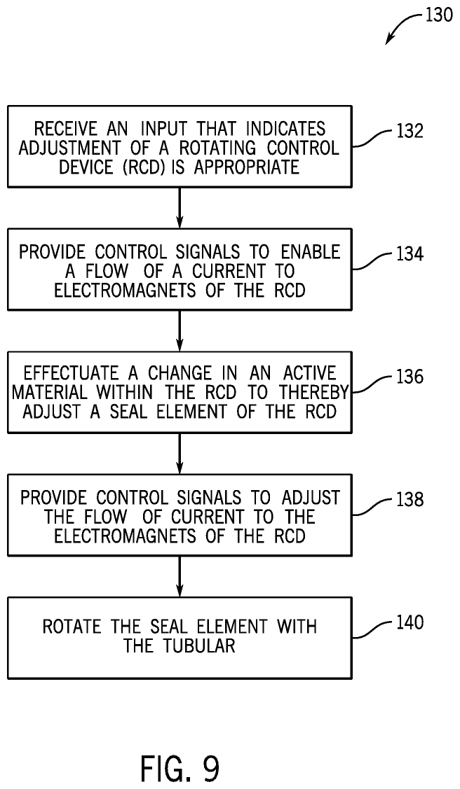

FIG. 9 is a flow diagram of an embodiment of a method 130 of operating an RCD having an active material, such as the RCD 44. The method 130 includes various steps represented by blocks. It should be noted that some or all of the steps of the method 130 may be performed as an automated procedure by a controller, such as the controller 60. Although the flow chart illustrates the steps in a certain sequence, it should be understood that the steps may be performed in any suitable order and certain steps may be carried out simultaneously, where appropriate. Further, certain steps or portions of the method 130 may be omitted and other steps may be added.

As shown, in step 132, the controller 60 may receive an input that indicates that adjustment of the RCD 44 is appropriate. For example, the input may be received from a user interface (e.g., input by the operator) and/or the input may be received from one or more sensors. In step 134, the controller 60 may provide control signals to provide a current to electromagnets 58 of the RCD 44. The current may generate a magnetic field as the current flows through windings of the electromagnets 58.

In step 136, the active material may deform in response to the application of the magnetic field. For example, the active material may be within the seal element 50 or may be positioned circumferentially about the seal element 50 (e.g., in the push element 52; in the chamber 100), and the active material may adjust the position of the seal element 50 relative to the tubular 36. In some embodiments, the application of the magnetic field may drive the seal element 50 toward the tubular 36. In some embodiments, the application of the magnetic field may enable or cause the seal element 50 to move away from the tubular 36.

In step 138, the controller 60 may continue to adjust (e.g., periodically, continuously, and/or in response to one or more inputs) the current to the electromagnets 58 to adjust the position of the seal element 50 relative to the tubular 36 to thereby provide an adjustable and dynamic seal about the tubular 36. In step 140, the seal element 50 (and/or additional components, such as the push element 52 or the bracket 120) may rotate with the tubular 36 via the bearing 80 within the RCD 44.

It should be appreciated that the illustrated embodiments are merely exemplary and are not intended to be limiting. Any suitable configuration of the seal element 50, the push element 52, and/or other components that enable the application of the magnetic field or the electric field to adjust the position of the seal element 50 relative to the tubular 36 to thereby form and/or adjust the seal about the tubular 36 are envisioned. As noted above, any features shown or described with respect to FIGS. 1-9 may be combined in any suitable manner.

While the disclosure may be susceptible to various modifications and alternative forms, specific embodiments have been shown by way of example in the drawings and have been described in detail herein. However, it should be understood that the disclosure is not intended to be limited to the particular forms disclosed. Rather, the disclosure is intended to cover all modifications, equivalents, and alternatives falling within the spirit and scope of the disclosure as defined by the following appended claims.

1. A rotating control device (RCD), comprising:
a housing defining a bore;
a seal element supported within the housing and configured to form a seal against a tubular within the bore; and
an active material within the housing, wherein the active material is configured to deform upon application of a magnetic field or an electric field to thereby adjust the seal against the tubular.

2. The RCD of claim 1, wherein the active material comprises a magnetostrictive material and is configured to deform upon application of the magnetic field.

3. The RCD of claim 2, wherein the active material comprises a magnetorheological fluid and is configured to deform upon application of the magnetic field.

4. The RCD of claim 2, comprising one or more electromagnets supported within the housing.

5. The RCD of claim 1, wherein the active material is positioned radially-outwardly of the seal element.

6. The RCD of claim 5, comprising a push element that is positioned radially-outwardly of the seal element, wherein the active material is encapsulated within the push element.

7. The RCD of claim 5, comprising a push element that is positioned radially-outwardly of the seal element, wherein the active material forms the push element.

8. The RCD of claim 1, comprising bearings that enable the seal element to rotate relative to the housing.

9. The RCD of claim 1, wherein the active material is encapsulated within the seal element.

10. The RCD of claim 1, wherein the active material forms the seal element.

11. The RCD of claim 1, wherein the active material is configured to bend upon application of the magnetic field or the electric field to thereby adjust the seal against the tubular.

12. The RCD of claim 1, wherein the active material comprises a fluid supported within a chamber, and the fluid is configured to change a viscosity upon application of the magnetic field or the electric field to thereby adjust the seal against the tubular.

13. The RCD of claim 12, wherein the chamber is fluidly coupled to a fluid circuit to enable circulation of the fluid through the chamber.

14. A rotating control device (RCD) system, comprising:
a housing defining a bore and an annular cavity;
an annular seal element supported within the annular cavity of the housing and configured to form an annular seal against a tubular within the bore; and
an active material supported within the annular cavity of the housing, wherein the active material is configured to deform upon application of a magnetic field or an electric field to thereby adjust the annular seal against the tubular.

15. The RCD system of claim 14, comprising a controller configured to adjust a current or a voltage to apply the magnetic field or the electric field to the active material.

16. The RCD system of claim 15, wherein the controller is configured to adjust the current or the voltage in response to an input received from a user interface.

17. The RCD system of claim 14, wherein the active material comprises a magnetostrictive material and is configured to deform upon application of the magnetic field.

18. The RCD system of claim 17, comprising one or more electromagnets supported within the housing.

19. The RCD system of claim 14, wherein the active material is positioned radially-outwardly of the annular seal element.

20. A method of operating a rotating control device (RCD), the method comprising:
receiving, at one or more processors, signals that indicate that adjustment of a seal between a seal element of the RCD and a tubular extending through a bore of the RCD is appropriate; and
controlling, using the one or more processors, a current to one or more electromagnets of the RCD in response to receiving the signals to thereby deform an active material within the RCD to adjust the seal between the seal element of the RCD and the tubular.
